(19) United States
(12) Patent Application Publication
(10) Pub. No.: US 2026/0142965 A1
(43) Pub. Date: May 21, 2026

(54) MULTI-FACTOR AUTHENTICATION ASSISTED AUTO-REGISTRATION

(71) Applicant: Lenovo Global Technology (United States) Inc., Morrisville, NC (US)

(72) Inventors: Alexandru Cozma, Bucharest (RO); Fred Allison Bower, III, Durham, NC (US)

(21) Appl. No.: 18/949,872

(22) Filed: Nov. 15, 2024

(51) Int. Cl. H04L 9/40

(52) U.S. Cl. CPC H04L 63/083; H04L 63/0876; H04L 2463/082

(57) ABSTRACT

A method for multi-factor authentication (“MFA”) assisted auto-registration includes receiving, at an on-premises computing system and from a cloud service portal a software package for installation at the on-premises computing system. The software package includes a first authentication payload. The method includes receiving, at the on-premises computing system and from a user device, a second authentication payload and presenting, by the on-premises computing system and to the cloud service portal, at least a portion of the first authentication payload and at least a portion of the second authentication payload. The method includes establishing a secured connection between the cloud service portal and the on-premises computing system for accessing services via the cloud service portal in response to a successful validation of the first authentication payload and the second authentication payload.

### FIELD

The subject matter disclosed herein relates to multi-factor authentication (“MFA”) and more particularly relates to MFA assisted auto-registration.

### BACKGROUND

In hybrid cloud ecosystems, an on-premises computing system generally needs to register with a cloud service portal via a bi-directional authentication process. The typical process to support the bi-directional authentication requires a user of a user device to generate a secure token that binds the identity of the on-premises computing system and the cloud service portal to one another. This process is cumbersome and creates security risks.

### BRIEF SUMMARY

A method for MFA assisted auto-registration is disclosed. An apparatus and system also perform the functions of the method. The method includes receiving, at an on-premises computing system and from a cloud service portal a software package for installation at the on-premises computing system. The software package includes a first authentication payload. The method includes receiving, at the on-premises computing system and from a user device, a second authentication payload and presenting, by the on-premises computing system and to the cloud service portal, at least a portion of the first authentication payload and at least a portion of the second authentication payload. The method includes establishing a secured connection between the cloud service portal and the on-premises computing system for accessing services via the cloud service portal in response to a successful validation of the first authentication payload and the second authentication payload.

An apparatus for MFA assisted auto-registration includes a processor and non-transitory computer readable storage media storing code. The code is executable by the processor to perform operations that include receiving, at an on-premises computing system and from a cloud service portal a software package for installation at the on-premises computing system. The software package includes a first authentication payload. The operations include receiving, at the on-premises computing system and from a user device, a second authentication payload and presenting, by the on-premises computing system and to the cloud service portal, at least a portion of the first authentication payload and at least a portion of the second authentication payload. The operations include establishing a secured connection between the cloud service portal and the on-premises computing system for accessing services via the cloud service portal in response to a successful validation of the first authentication payload and the second authentication payload.

A system for MFA assisted auto-registration is disclosed. The system includes a cloud service portal and an on-premises computing system in communication with the cloud service portal. The on-premises computing system includes a processor and a non-transitory computer readable storage media. The on-premises computing system is configured to receive, at the on-premises computing system and from the cloud service portal a software package for installation at the on-premises computing system. The software package includes a first authentication payload. The on-premises computing system is configured to receive, at the on-premises computing system and from a user device, a second authentication payload and present, by the on-premises computing system and to the cloud service portal, at least a portion of the first authentication payload and at least a portion of the second authentication payload. The on-premises computing system is configured to establish a secured connection between the cloud service portal and the on-premises computing system for accessing services via the cloud service portal in response to a successful validation of the first authentication payload and the second authentication payload.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating a system for a multi-factor authentication (“MFA”) assisted auto-registration, according to various embodiments;

FIG. 2 is a schematic block diagram illustrating an apparatus for an MFA assisted auto-registration, according to various embodiments;

FIG. 3 is a schematic block diagram illustrating another apparatus for an MFA assisted auto-registration, according to various embodiments;

FIG. 4 is a sequence diagram illustrating another system for an MFA assisted auto-registration, according to various embodiments;

FIG. 5 is a schematic flow chart diagram illustrating a method for an MFA assisted auto-registration, according to various embodiments; and

FIG. 6 is a schematic flow chart diagram illustrating another method for an MFA assisted auto-registration, according to various embodiments.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the "C" programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

A method for MFA assisted auto-registration is disclosed. An apparatus and computer program product also perform the functions of the method. The method includes receiving, at an on-premises computing system and from a cloud service portal a software package for installation at the on-premises computing system. The software package includes a first authentication payload. The method includes receiving, from a user device, a second authentication payload and presenting the first authentication payload and the second authentication payload to the cloud service portal. The method includes establishing a secured connection between the cloud service portal and the on-premises computing system for accessing services via the cloud service portal in response to a successful validation of the first authentication payload and the second authentication payload.

In some embodiments, the first authentication payload includes a pre-registration payload. The pre-registration payload is derived at the cloud service portal based on a set of user credentials and a successful authentication of the user device. In some embodiments, the on-premises computing device automatically registers with the cloud service portal in response to receiving the pre-registration payload. In some embodiments, the first authentication payload includes a certificate. The certificate associates the software package with the user device. In some embodiments, the first authentication payload originates at the cloud service portal and in some embodiments, the first authentication payload is routed through the user device to be received at the on-premises computing system. In some embodiments, the software package is customized based on the user of the user device and/or an organization.

In some embodiments, the second authentication payload includes a MFA payload that is generated, during an installation of the software package on the on-premises computing system, at the user device based on an authentication token, a successful MFA authentication, and the first authentication payload. In some embodiments the authentication token is received from either the cloud service portal or an MFA server associated with the cloud service portal. In some embodiments, a request is sent, during the installation of the software package, to either the cloud service portal or the MFA server associated with the cloud service portal to create an MFA challenge that sends the authentication token to the user device. In some embodiments, the authentication token includes a one-time password (“OTP”).

In some embodiments, the method includes receiving one or more additional authentication payloads from the user device based on a context associated with the user device. In some embodiments, the one or more additional authentication payloads are derived at the user device based on one or more additional authentication tokens received from another user device. The another user device is trusted by the on-premises computing system.

In some embodiments, the method includes presenting the one or more additional authentication payloads along with the first authentication payload and the second authentication payload to the cloud service portal to access the services via the cloud service portal. In some embodiments presenting the first authentication payload and the second authentication payload to the cloud service portal includes binding the first authentication payload with the second authentication payload.

An apparatus for MFA assisted auto-registration includes a processor and non-transitory computer readable storage media storing code. The code is executable by the processor to perform operations that include receiving, at an on-premises computing system and from a cloud service portal a software package for installation at the on-premises computing system. The software package includes a first authentication payload. The operations include receiving, from a user device, a second authentication payload and presenting the first authentication payload and the second authentication payload to the cloud service portal. The operations include establishing a secured connection between the cloud service portal and the on-premises computing system for accessing services via the cloud service portal in response to a successful validation of the first authentication payload and the second authentication payload.

In some embodiments, the first authentication payload includes a pre-registration payload. The pre-registration payload is derived at the cloud service portal based on a set of user credentials and a successful authentication of the user device. In some embodiments, the on-premises computing device automatically registers with the cloud service portal in response to receiving the pre-registration payload. In some embodiments, the first authentication payload includes a certificate. The certificate associates the software package with the user device. In some embodiments, the first authentication payload originates at the cloud service portal and in some embodiments, the first authentication payload is routed through the user device to be received at the on-premises computing system. In some embodiments, the software package is customized based on the user of the user device and/or an organization.

In some embodiments, the second authentication payload includes a multi-factor (“MFA”) payload that is generated, during an installation of the software package on the on-premises computing system, at the user device based on an authentication token, a successful MFA authentication, and the first authentication payload. In some embodiments the authentication token is received from either the cloud service portal or an MFA server associated with the cloud service portal. In some embodiments, a request is sent, during the installation of the software package, to either the cloud service portal or the MFA server associated with the cloud service portal, to create an MFA challenge that sends the authentication token to the user device. In some embodiments, the authentication token includes a one-time password (“OTP”).

In some embodiments, the operations include receiving one or more additional authentication payloads from the user device based on a context associated with the user device, In some embodiments, the one or more additional authentication payloads are derived at the user device based on one or more additional authentication tokens received from another user device. The another user device is trusted by the on-premises computing system.

In some embodiments, the operations include presenting the one or more additional authentication payloads along with the first authentication payload and the second authentication payload to the cloud service portal to access the services via the cloud service portal. In some embodiments presenting the first authentication payload and the second authentication payload to the cloud service portal includes binding the first factor of authentication payload with the second factor of authentication payload.

A system for MFA assisted auto-registration is disclosed. The system includes a cloud service portal and an on-premises computing system in communication with the cloud service portal. The on-premises computing system includes a processor and a non-transitory computer readable storage media. The on-premises computing system is configured to receive, at the on-premises computing system and from the cloud service portal a software package for installation at the on-premises computing system. The software package includes a first authentication payload. The on-premises computing system is configured to receive, from a user device, a second authentication payload and present the first authentication payload and the second authentication payload to the cloud service portal. The on-premises computing system is configured to establish a secured connection between the cloud service portal and the on-premises computing system for accessing services via the cloud service portal in response to a successful validation of the first authentication payload and the second authentication payload.

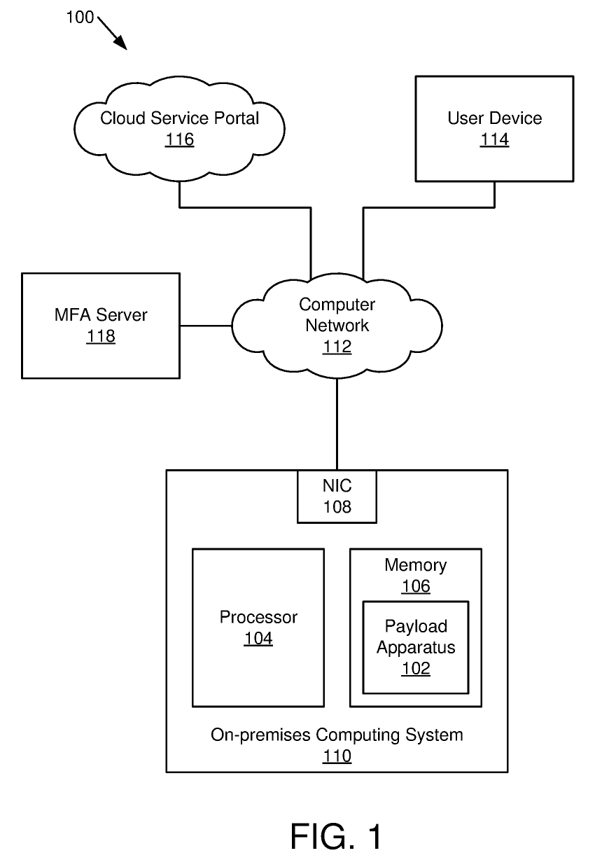

FIG. 1 is a schematic block diagram illustrating a system 100 for a multi-factor authentication (“MFA”) assisted auto-registration, according to various embodiments. The system 100 includes an on-premises computing system 110, a computer network 112, a user device 114, a cloud service portal 116 and an MFA server 118. The on-premises computing system 110 includes a payload apparatus 102, a processor 104, a memory 106, and a network interface card (“NIC”) 108. The on-premises computing system 110 may further include, in general, a non-volatile memory, a communication bus, etc.

In hybrid cloud ecosystems, the on-premises computing system 110 generally need to register with the cloud service portal 116 via a bi-directional authentication process. The bi-directional authentication process assures that the on-premises computing system 110 connecting to the cloud service portal 116 is authorized to connect and that the cloud service portal 116 to which the on-premises computing system 110 is connecting to is authentic. The typical process to support the bi-directional authentication requires a user of the user device 114 to generate a secure token that binds the identity of the on-premises computing system 110 and the cloud service portal 116 to one another. For example, the user logs into a cloud portion of the cloud service portal 116 (e.g., a first user interface) in the user device 114 and generates a connector token and passes the generated connector token to the on-premises portion of the on-premises computing system 110 (e.g., a second user interface) in the user device 114. The on-premises portion generates a response token by using a set of data associated with the connector token. The user enters back the response token into the cloud portion and a connection is established based on a set of data provided in the response token. This process requires the user to establish a session on both the cloud service portal 116 and the on-premises computing device 110 and manually ferry the connector tokens and the response token between the cloud portion and the on-premises portion to initiate a connection.

The payload apparatus 102 enables the on-premises computing system 110 to receive a software package that includes a pre-registration payload which enables the on-premises computing system 110 to automatically register with the cloud service portal 116. The payload apparatus 102 may further provide security during events such an attempt to steal or copy software, the user device 114 being exposed, the on-premises computing system 110 being exposed, or the like, by using an MFA mechanism. The payload apparatus 102 advantageously enables a secure bi-directional authentication from a single user interface flow, eliminating the need for the user to switch between the cloud portion and the on-premises portion (e.g., the first user interface and the second interface respectively) and the need for establishing the session on both the cloud service portal 116 and the on-premises computing system 110.

In some embodiments, the payload apparatus 102 receives, at the on-premises computing system 110 and from a cloud service portal 116 a software package for installation at the on-premises computing system 110. The software package, in some embodiments, includes a first authentication payload. In some embodiments, the software package may be received at the on-premises computing system 110 in response the user device 114 initiating a download of the software package.

In some embodiments, the first authentication payload may include a pre-registration payload, and a certificate which associates the software package with the user device 114. The pre-registration payload may be a set of data that is derived at the cloud service portal 116 based on the user credentials and a successful authentication of the user device 114. For example, the user registers with the cloud service portal 116 by creating a set of user credentials (e.g., a username and a password). The cloud service portal 116 authenticates the user device 114 based on the user credentials and derives the pre-registration payload based on the user credentials and the successful authentication of the user device 114.

The pre-registration payload, in some embodiments, enables the on-premises computing system 110 to automatically register with the cloud service portal 116. In some embodiments, the pre-registration payload may include a set of instructions that may be executed by the payload apparatus 102 to automatically register the on-premises computing system 110 with the cloud service portal 116.

The cloud service portal 116, in some embodiments, transmits the software package along with the first authentication payload to the on-premises computing system 110. In some embodiments, the first authentication payload may be routed from the cloud service portal 116 to the on-premises computing system 110, through the user device 114.

In some embodiments, the payload apparatus 102 receives from a user device 114, a second authentication payload. The second authentication payload, in some embodiments, may include an MFA payload which is derived at the user device 114 based on an authentication token (e.g., an MFA token, a one-time password (“OTP”), etc.), a successful MFA authentication, and the first authentication payload.

In general, MFA is a security method that requires users to provide more than just a password to access an account or website. MFA may also be referred to as two-step verification. For example, when a user is signing in to an account on a new device or application, the user may need to enter a username and password and may also need to enter a unique number (e.g., an OTP) that was received from an MFA server 118. The MFA mechanism may include various types of factors such as a password, a security token, a keycard, fingerprint scan, and/or iris scan.

The authentication token, in some embodiments, may refer to an OTP received from either the cloud service portal 116 or the MFA server 118 associated with the cloud service portal 116. In some embodiments, the on-premises computing system 110, during the installation of the software package, may request one of the cloud service portal 116 and the MFA server 118, based on the first authentication payload, to create an MFA challenge that sends the authentication token to the user device 114. For example, the user device 114 receives a challenge from either the cloud service portal 116 or the MFA server 118 associated with the cloud service portal 116 to prove its identity. When one of the cloud service portal 116 and the MFA server 118 sends the authentication token to the user on the user device 114 or another personal device (a tablet, a mobile phone, etc.) of the user, the user may respond to the challenge with the received authentication token.

The payload apparatus 102, in some embodiments, presents at least a portion of the first authentication payload and at least a portion of the second authentication payload to the cloud service portal 116. In some embodiments, the payload apparatus 102, establishes a secured connection between the cloud service portal 116 and the on-premises computing system 110 for accessing services via the cloud service portal 116 in response to the successful validation of the first authentication payload and the second authentication payload.

The on-premises computing system 110, in various embodiments, may host the services received from cloud service portal 116. The on-premises computing system 110 may be, for example, a data center, an edge server, a workstation, a computer system, etc. It should be noted that the on-premises computing system 110 as illustrated and hereinafter described is merely illustrative of an apparatus that could benefit from embodiments of the present disclosure and, therefore, should not be taken to limit the scope of the present disclosure. It should be noted that the on-premises computing system 110 may include fewer or more components than those depicted in FIG. 1. The on-premises computing system 110 may be associated with a customer (e.g., an organization) that includes one or more users. In general, the on-premises computing system 110 may be used by the one or more users of an organization for remote storage, computing power, or distribution of large amounts of data.

The user device 114, in various embodiments, may be used by a user to access the services which are hosted by the on-premises computing system. The user device 114 may be an electronic device such as a desktop, a laptop, a tablet, a mobile phone, etc. In some embodiments, the user device 114 initiates a download, based on an input received from the user, to receive the software package along with the first authentication payload, at the on-premises computing system 110. The software package includes software that runs at the on-premises computing system 110. In some embodiments, the software package may be a software/application that runs in the background either while the user is away or to support another software/application that is actively used by the user. In some embodiments, the software package may be an application that is actively used by a user. In some embodiments the software package may be a software that runs on a virtual machine, or a physical machine. In some embodiments, the software package may be one or more virtual machines, one or more open virtual appliances (“OVA”), a set of containers, or the like.

The cloud service portal 116, in various embodiments, may provide one or more services to an organization and the one or more users in the organization. The cloud service portal 116 may be for example a cloud service provider (e.g., a third-party provider) that provides resources such as storage, servers, software, networking, etc. For example, the cloud service portal 116 may be a part of a company that offers cloud-based services to customers over a network (e.g., Internet). In general, the cloud services are hosted in a data center and can be accessed by customers using network connectivity. In some embodiments, the cloud service portal 116 may include its own MFA mechanism.

The system 100, in some embodiments, includes an MFA server 118 which provides MFA services. The MFA server 118 may be used by the cloud service portal 116 over a computer network 112 to access MFA services. In some embodiments, the MFA server 118, may include multiple types of authentication factors such as OTP, fingerprint scan, iris scan, facial recognition, etc. In some embodiments, the MFA server 118 may send the OTP (e.g., the authentication tokens) through email, short message service (“SMS”), a phone call, or the like, based on a user preference. In some embodiments, the cloud service portal 116 may include the MFA server 118.

The NIC 108 enables the on-premises computing system 110 to connect to a network and communicate with other devices (e.g., the cloud service portal 116, the user device 114, and/or the MFA server 118) on the computer network 112.

The computer network 112 is used by the on-premises computing system 110, the user device 114, the cloud service portal 116, and the MFA server 118 to connect to one another. The computer network 112, in some embodiments, includes a LAN, a WAN, a fiber network, a wireless connection, the Internet, or the like. In some embodiments, the computer network 112 includes two or more networks. In some embodiments, the computer network 112 includes servers, wiring, switches, routers, etc.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a BLUETOOTH® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (“ASTM”®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

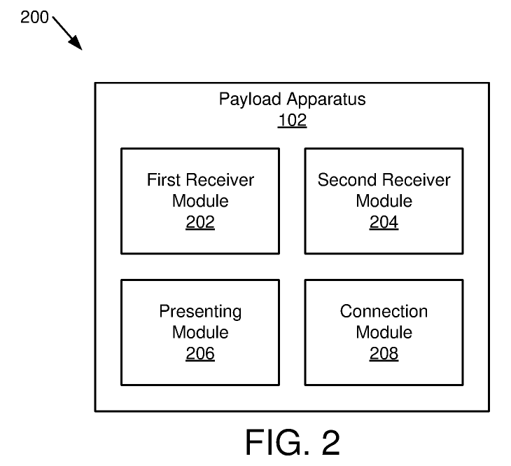

FIG. 2 is a schematic block diagram illustrating an apparatus 200 for an MFA assisted auto-registration, according to various embodiments. The apparatus 200 includes a payload apparatus 102 that includes a first receiver module 202, a second receiver module 204, a presenting module 206, and a connection module 208. In some embodiments, the apparatus 200 is implemented using executable code stored on a computer readable storage device, which is non-transitory. The code is executable on a processor. In other embodiments, all or a portion of the apparatus 200 is implemented using a programmable hardware device and/or hardware circuits.

The apparatus 200 includes a first receiver module 202 configured to receive, at an on-premises computing system 110 and from a cloud service portal 116 a software package for installation at the on-premises computing system 110. The software package includes a first authentication payload. In some embodiments, the cloud service portal 116 transmits the software package in response to the user initiating a download of the software package. In some embodiments, the user device 114 provides, during the initiation of the download, information related to the on-premises computing system 110 such as device identity, address, etc. to the cloud service portal 116 to transmit the software package to the desired on-premises computing system 110.

In some embodiments, the first authentication payload includes a pre-registration payload which is derived at the cloud service portal 116 based on a set of user credentials and a successful authentication of the user device 114. For example, the user registers with the cloud service portal 116 by creating a set of user credentials (e.g., a username and a password). The cloud service portal 116 authenticates the user device 114 based on the set of credentials entered by the user and derives a first authentication payload in response to successful authentication of the user device 114. In some embodiments, the first authentication payload is used as proof or an indication that the user device 114 was successfully authenticated by the cloud service portal 116.

In some embodiments, the pre-registration payload is used to automatically register the on-premises computing system 110 with the cloud service portal 116. In some embodiments, the pre-registration payload includes a set of instructions, that is executed by the on-premises computing system 110 to automatically register with the cloud service portal 116.

In some embodiments, the first authentication payload includes a certificate that associates the software package with a user or a user account. In some embodiments, the certificate includes one or more identity information of the cloud service portal 116. In some embodiments, the certificate of the cloud service portal 116 enables the payload apparatus 102 to determine which device (e.g., either the cloud service portal 116 or the MFA server 118 associated with the cloud service portal 116) needs to be requested to create the MFA challenge for the user device 114. For example, when a user is installing and configuring the software package, the payload apparatus 102 may have knowledge from the certificate, regarding which device (e.g., either the cloud service portal 116 or the MFA server 118 associated with the cloud service portal 116) has to be requested to create the MFA challenge.

In some embodiments, the software package is customized based on the user of the user device 114 or an organization. In some examples, a user or an entire organization may have a customized download. For example, a user may have, in their downloaded software package, special content with special services. The user, to access the special services, may require a second factor of authentication (e.g., MFA).

In some embodiments, the first authentication payload originates at the cloud service portal 116 and in some embodiments, the first authentication payload is routed through the user device 114 to be received at the on-premises computing system 110. In some examples, the cloud service portal 116 sends the first authentication payload to the user device 114 and the user device 114 provides the first authentication payload to the on-premises computing system 110. In some embodiments, the user device 114 uses the first authentication payload for installation and instantiation of the software package.

The apparatus 200 includes a second receiver module 204 configured to receive from a user device 114, a second authentication payload. In some embodiments, the second authentication payload includes an MFA payload derived, during an installation of the software package, at the user device 114 based on an authentication token, a successful MFA authentication, and the first authentication payload. In some embodiments, if the MFA authentication was performed by the cloud service portal 116, the second authentication payload is used as proof or an indication that the user device 114 was successfully authenticated by the MFA mechanism of the cloud service portal 116. In other embodiments, if the MFA authentication was performed by the MFA server 118 associated with the cloud service portal 116, the second authentication payload is used as proof or an indication that the user device 114 was successfully authenticated by the MFA server 118 associated with the cloud service portal 116.

In some embodiments, the authentication token may be received from the cloud service portal 116. In other embodiments, the authentication token is received from an MFA server 118 associated with the cloud service portal 116. In some embodiments, the authentication token is an OTP. In some embodiments the on-premises computing system 110 sends a request during the installation of the software package, to either the cloud service portal 116 or the MFA server 118 associated with the cloud service portal 116, to create an MFA challenge to that transmits the authentication token to the user device 114.

The apparatus 200 includes a presenting module 206 configured to present, the first authentication payload and the second authentication payload to the cloud service portal 116. In some embodiment, the payload apparatus 102 may bind the first authentication payload with the second authentication payload present at the cloud service portal 116. In some embodiments, presenting the first authentication payload and the second authentication payload may refer to transmitting the first authentication payload and the second authentication payload for validation of the first authentication payload and the second authentication payload by the cloud service portal 116. In some embodiments, the presenting module 206 may send a connection request along with the first authentication payload and the second authentication payload.

The apparatus 200 includes a connection module 208 configured to establish a secured connection between the cloud service portal 116 and the on-premises computing system 110 for accessing services via the cloud service portal 116 in response to the successful validation of the first authentication payload and the second authentication payload. In various embodiments, the cloud service portal 116 accepts the connection upon determining that both, the first authentication payload and the second authentication payload were received and determining that both, the first authentication payload and the second authentication payload are valid.

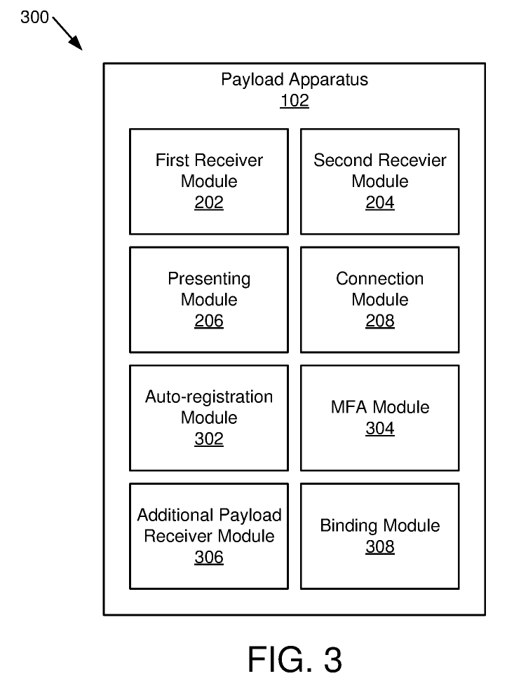

FIG. 3 is a schematic block diagram illustrating another apparatus 300 for an MFA assisted auto-registration, according to various embodiments. The apparatus 300 includes the payload apparatus 102 that includes a first receiver module 202, a second receiver module 204, a presenting module 206, and a connection module 208 which are substantially similar to those described above in relation the apparatus 200 of FIG. 2. In the implementation shown in FIG. 3, the payload apparatus 102 may additionally include, in various embodiments, one or more of: an auto-registration module 302, MFA module 304, additional payload receiver module 306, a binding module 308, or any combination thereof. In various embodiments, all or a portion of the apparatus 300 is implemented similar to the apparatus 200 of FIG. 2.

The apparatus 300, in some embodiments, includes an auto-registration module 302 configured to automatically register the on-premises computing system 110 with the cloud service portal 116 in response to receiving the pre-registration payload. In some embodiments, the pre-registration payload includes the set of user credentials which was used by the user device 114 to register with the cloud service portal 116. For example, the user credentials may be converted into a secured digital code that is equivalent to the user credentials which was used by the user to register with the cloud service portal 116. In some embodiments, the pre-registration payload may include a secured token that is equivalent to the user credentials.

The apparatus 300, in some embodiments, includes an MFA module 304 configured to send a request, during the installation of the software package, to either the cloud service portal 116 or the MFA server 118 associated with the cloud service portal 116, to create an MFA challenge that sends the authentication token to the user device 114. In some embodiments, the request sent by the MFA module 304 may include an indication to authenticate the user device 114 by using an MFA mechanism. In some embodiments, the on-premises computing system 110 uses the certificate received from the could service portal to determine which device (e.g., either the cloud service portal 116 or the MFA server 118 associated with the cloud service portal 116) needs to be requested to create the MFA challenge for the user device 114.

In some embodiments, the MFA module 304 sends the request, to either the cloud service portal 116 or the MFA sever associated with the cloud service portal 116, in response to receiving one or more installation instructions from the user device 114. In some embodiments, the one or more installation instructions includes one or more configuration instructions. In some embodiments, the MFA module 304 sends the request, to either the cloud service portal 116 or the MFA sever associated with the cloud service portal 116, during a configuration of the software package.

In some embodiments, the MFA module 304 indicates the cloud service portal 116 or the MFA server 118 to send the authentication token to the user device 114 based on the user’s preferred delivery method, for example, an email, a text message, a phone call, or the like.

The apparatus 300, in some embodiments, includes an additional payload receiver module 306 configured to receive one or more additional authentication payloads from the user device 114 based on a context associated with the user device 114. The one or more additional authentication payloads are derived at the user device 114 based on one or more additional authentication tokens received from another user device 114, which may be trusted by the on-premises computing system 110. In some examples, if the context is that a user is an independent contractor in an organization and another user is an employee in the organization who has previously trust with the on-premises computing system 110, then the on-premises computing system 110 may require the independent contractor to provide an additional authentication payload which is derived based on one or more additional authentication tokens received from the employee, and a successful authentication of the independent contractor by the employee.

The apparatus 300, in some embodiments, includes a binding module 308 configured to bind the first authentication payload, the second authentication payload and the one or more additional authentication payload prior to presenting the first authentication payload, the second authentication payload and the one or more additional authentication payload to the cloud service portal 116.

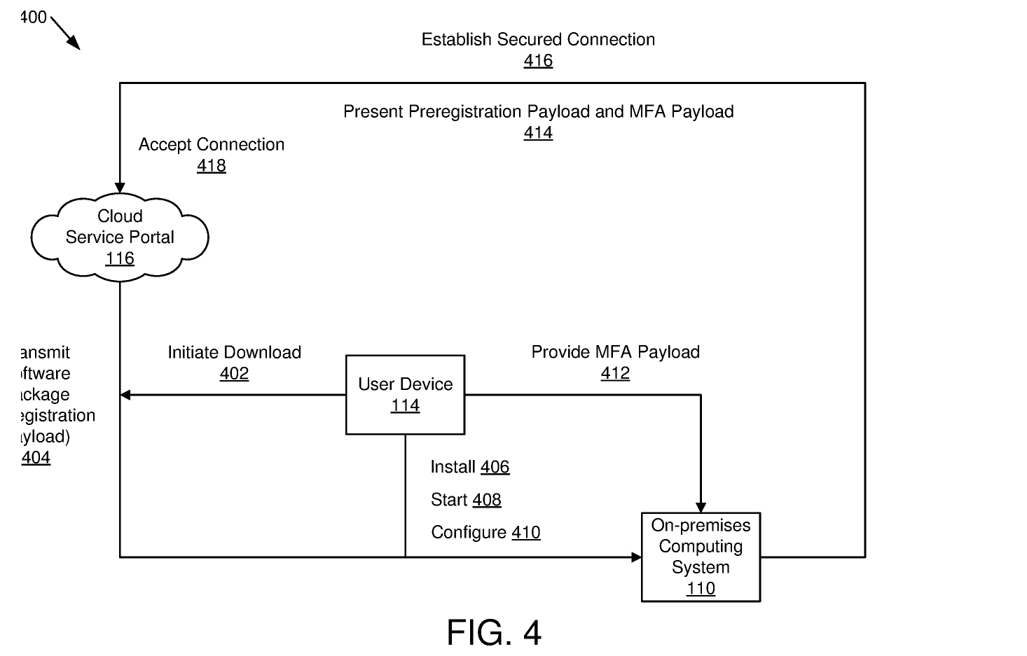

FIG. 4 is a sequence diagram illustrating another system 400 for an MFA assisted auto-registration, according to various embodiments. The system 400 includes an on-premises computing system 110, a user device 114 and a cloud service portal 116.

In some embodiments, the user device 114 initiates 402 a download of the software package from the cloud service portal 116. In some embodiments, the user registers with the cloud service portal 116 by using a set of user credentials (e.g., a username and a password) to initiate 402 the download. In some embodiments, the cloud service portal 116 authenticates the user based on the set of user credentials.

In some embodiment, initiation of the download of the software package includes requesting the cloud service portal 116 to transmit the software package to the on-premises computing system 110. In some embodiments, the initiation of the download of the software package includes requesting the cloud service portal 116 to automatically register the on-premises computing system 110 with the cloud service portal 116. In some embodiments, the cloud service portal 116 derives a pre-registration payload based on the set of user credentials and a successful authentication of the user.

In some embodiments, the cloud service portal 116 transmits 404 a software package along with the pre-registration payload in response to the successful authentication of the user. In some embodiments, the cloud service portal 116 sends the pre-registration payload, in response to receiving a request to automatically register the on-premises computing system 110 with the cloud service portal 116. In some embodiments, cloud service portal 116 routes the pre-registration payload through the user device 114 to send to the on-premises computing system 110. In some embodiments, the user device 114 uses the pre-registration payload for installation and instantiation of the software package.

In some embodiments, the user by using the user device 114, installs 406 the software package on the on-premises computing system 110 that was received at the cloud service portal 116 and starts 408 the software. In some embodiments, the user by using the user device 114, configures 410 the software package installed at the on-premises computing system 110. In some embodiments, the on-premises computing system 110, during the configuration of the software package, requests either the cloud service portal 116 or the MFA server 118 associated with the cloud service portal 116 to create an MFA challenge to the user that sends an authentication token to the user device 114. In some examples, the cloud service portal 116 or the MFA server 118 associated with the cloud service portal 116 receives a request to issue an MFA challenge to the user. For example, the user receives an authentication token (e.g., an OTP) from either the cloud service portal 116 or the MFA server 118 associated with the cloud service portal 116, that the user needs to enter on the user device 114 for a successful MFA authentication. In some embodiments, the user receives the authentication token through his/her preferred delivery method (e.g., an email, a text message, a phone call, or the like). In some embodiments, the user receives on his/her user device 114, a pop-up window where the user may enter the authentication token that was received.

In some embodiments, the user device 114 provides 412 the MFA payload to the on-premises computing system 110. In some embodiments, the user device 114 derives an MFA payload based on the authentication token (e.g., the OTP), a successful MFA authentication and the pre-registration payload. In some embodiments, the successful MFA authentication refers to the user being successfully authenticated by the cloud service portal 116 or the MFA server 118 associated with the cloud service portal 116.

In some embodiments, the on-premises computing system 110 presents 414 the pre-registration payload and the MFA payload to the cloud service portal 116. The on-premises computing system 110, in some embodiments, binds the pre-registration payload with the MFA payload, prior to presenting the pre-registration payload and the MFA payload to the cloud service portal 116. In some embodiments, the on-premises computing system 110 establish 416 a secured connection with the cloud service portal 116 based on the pre-registration payload and the MFA payload. In some embodiments, the cloud service portal 116 validates the pre-registration payload and the MFA payload received from the on-premises computing system 110. In some embodiments, the cloud service portal 116 accepts 418 the connection in response to a successful validation of the pre-registration payload and the MFA payload.

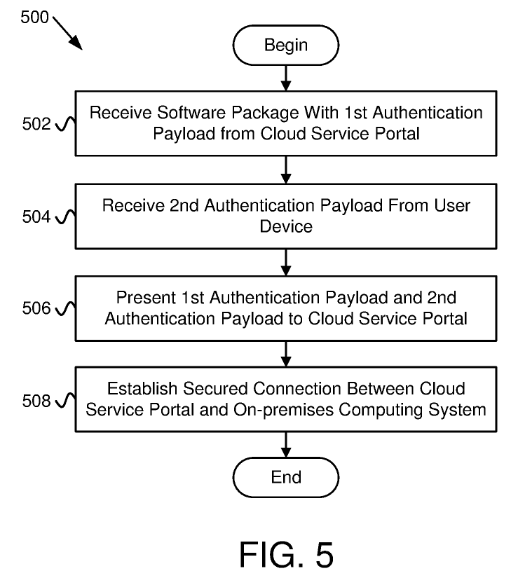

FIG. 5 is a schematic flow chart diagram illustrating a method 500 for an MFA assisted auto-registration, according to various embodiments. In some embodiments, the method 500 begins and receives 502, at the on-premises computing system 110 and from a cloud service portal 116 a software package for installation at the on-premises computing system 110. The software package includes a first authentication payload. In some embodiments, the first authentication payload includes a pre-registration payload where the pre-registration payload is derived at the cloud service portal 116 based on a set of user credentials and a successful authentication of the user device 114. In some embodiments, the on-premises computing system 110 automatically registers with the cloud service portal 116 in response to receiving the pre-registration payload.

In some embodiments, the first authentication payload originates at the cloud service portal 116. In some embodiments, the first authentication payload is routed through the user device 114 to be received at the on-premises computing system 110. In some embodiments, the authentication payload includes a certificate, the certificate associates the software package with the user device 114. In some embodiments, the software package includes an installation instance customized based on the user of the user device 114.

In some embodiments, the method 500 receives 504, from a user device 114, a second authentication payload. In some embodiments, the second authentication payload includes a MFA payload derived, during a installation of the software package, at the user device 114 based on an authentication token, a successful MFA authentication, and the first authentication payload where the authentication token is received from one of the cloud service portal 116 and an MFA server 118 associated with the cloud service portal 116. In some embodiments, the authentication token includes an OTP. In some embodiments the on-premises computing system 110 sends a request during the installation of the software package, to either the cloud service portal 116 or the MFA server 118 associated with the cloud service portal 116, to create an MFA challenge that sends the authentication token to the user device 114.

In some embodiments, the method 500 presents 506, the first authentication payload and the second authentication payload to the cloud service portal 116. In some embodiment, the first authentication payload and the second authentication payload binds together to be presented at the cloud service portal 116. In some embodiments, the method 500, establishes 508 a secured connection between the cloud service portal 116 and the on-premises computing system 110 for accessing services via the cloud service portal 116 in response to the successful validation of the first authentication payload and the second authentication payload, and the method 500 ends. In various embodiments, all or a portion of the method 500 is implemented using the first receiver module 202, the second receiver module 204, the presenting module 206, and/or the connection module 208.

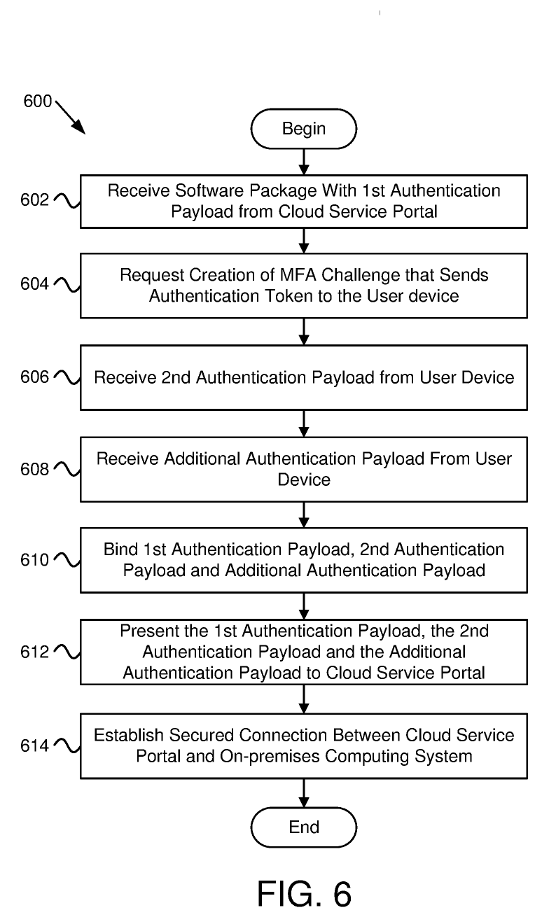

FIG. 6 is a schematic flow chart diagram illustrating another method 600 for an MFA assisted auto-registration, according to various embodiments. In some embodiments, the method 600 begins and receives 602, at the on-premises computing system and from a cloud service portal 116 a software package for installation at the on-premises computing system 110. The software package includes a first authentication payload. In some embodiments, the first authentication payload includes a pre-registration payload. The pre-registration payload is derived at the cloud service portal 116 based on a set of user credentials and a successful authentication of the user device 114. In some embodiments, the first authentication payload originates at the cloud service portal 116. In some embodiments, the on-premises computing system 110 automatically registers with the cloud service portal 116 in response to receiving the pre-registration payload.

In some embodiments, the first authentication payload is routed through the user device 114 to be received at the on-premises computing system 110. In some embodiments, the authentication payload includes a certificate where the certificate associates the software package with the user device 114. In some embodiments, the software package includes an installation instance customized based on the user of the user device 114.

In some embodiments, the method 600 requests 604 during the installation of the software package, to either the cloud service portal 116 or the MFA server 118 associated with the cloud service portal 116, to create an MFA challenge that sends the authentication token to the user device 114.

In some embodiments, the method 600 receives 606, from a user device 114, a second authentication payload. In some embodiments, the second authentication payload includes a MFA payload derived, during a installation of the software package, at the user device 114 based on an authentication token, a successful MFA authentication, and the first authentication payload where the authentication token is received from one of the cloud service portal 116 and an MFA server 118 associated with the cloud service portal 116. In some embodiments, the authentication token includes an OTP.

In some embodiments, the method 600 receives 608, one or more additional authentication payloads from the user device 114 based on a context associated with the user device 114 where the one or more additional authentication payloads are derived at the user device 114 based on one or more additional authentication tokens received from another user device 114, which is trusted by the on-premises computing system 110.

In some embodiments, the method 600 binds 610, the first authentication payload, the second authentication payload and the one or more additional authentication payloads and presents 612 the first authentication payload, the second authentication payload and the one or more additional authentication payloads to the cloud service portal 116. The method 600, establishes 614 a secured connection between the cloud service portal 116 and the on-premises computing system 110 for accessing services via the cloud service portal 116 in response to the successful validation of the first authentication payload, the second authentication payload and the one or more additional authentication payload, and the method 600 ends. In various embodiments, all or a portion of the method 600 is implemented using the first receiver module 202, the second receiver module 204, the presenting module 206, the connection module 208, the auto-registration module 302, the MFA module 304, the additional payload receiver module 306, and/or the binding module 308.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, at an on-premises computing system and from a cloud service portal a software package for installation at the on-premises computing system, wherein the software package comprises a first authentication payload;
receiving, at the on-premises computing system and from a user device, a second authentication payload;
presenting, by the on-premises computing system and to the cloud service portal, at least a portion of the first authentication payload and at least a portion of the second authentication payload; and
establishing a secured connection between the cloud service portal and the on-premises computing system for accessing services via the cloud service portal in response to a successful validation of the first authentication payload and the second authentication payload.

2. The method of claim 1, wherein the first authentication payload comprises a pre-registration payload, wherein the pre-registration payload is derived at the cloud service portal based on a set of user credentials and a successful authentication of the user device.

3. The method of claim 2, wherein the on-premises computing device automatically registers with the cloud service portal in response to receiving the pre-registration payload.

4. The method of claim 1, wherein the first authentication payload originates at the cloud service portal, and wherein the first authentication payload is routed through the user device to be received at the on-premises computing system.

5. The method of claim 1, wherein the first authentication payload comprises a certificate, wherein the certificate associates the software package with the user device.

6. The method of claim 1, wherein the second authentication payload comprises a multi-factor authentication (“MFA”) payload that is generated, during an installation of the software package on the on-premises computing system, at the user device based on an authentication token, a successful MFA authentication, and the first authentication payload, wherein the authentication token is received from one of the cloud service portal and an MFA server associated with the cloud service portal.

7. The method of claim 6, wherein a request is sent, during the installation of the software package, to one of the cloud service portal and the MFA server associated with the cloud service portal, to create an MFA challenge that sends the authentication token to the user device.

8. The method of claim 1, further comprising:
receiving one or more additional authentication payloads from the user device based on a context associated with the user device, wherein the one or more additional authentication payloads are derived at the user device based on one or more additional authentication tokens received from another user device, wherein the another user device is trusted by the on-premises computing system; and
presenting the one or more additional authentication payloads along with the first authentication payload and the second authentication payload to the cloud service portal to access the services via the cloud service portal.

9. The method of claim 1, wherein presenting the first authentication payload and the second authentication payload to the cloud service portal comprises binding the first authentication payload with the second authentication payload.

10. The method of claim 1, wherein the software package is customized based on a user of the user device and/or an organization.

11. The method of claim 6, wherein the authentication token comprises a one-time password (“OTP”).

12. An apparatus comprising:
a processor; and
non-transitory computer readable storage media storing code, the code being executable by the processor to perform operations comprising:
receiving, at an on-premises computing system and from a cloud service portal a software package for installation at the on-premises computing system, wherein the software package comprises a first authentication payload;
receiving, at the on-premises computing system and from a user device, a second authentication payload;
presenting, by the on-premises computing system and to the cloud service portal, at least a portion of the first authentication payload and at least a portion of the second authentication payload;
establishing a secured connection between the cloud service portal and the on-premises computing system for accessing services via the cloud service portal in response to a successful validation of the first authentication payload and the second authentication payload.

13. The apparatus of claim 12, wherein the first authentication payload comprises a pre-registration payload, wherein the pre-registration payload is derived at the cloud service portal based on a set of user credentials and a successful authentication of the user device.

14. The apparatus of claim 13, wherein the on-premises computing device automatically registers with the cloud service portal in response to receiving the pre-registration payload.

15. The apparatus of claim 12, wherein, the first authentication payload originates at the cloud service portal, and wherein the first authentication payload is routed through the user device to be received at the on-premises computing system.

16. The apparatus of claim 12, wherein the first authentication payload comprises a certificate, wherein the certificate associates the software package with the user device.

17. The apparatus of claim 12, wherein the second authentication payload comprises a multi-factor (“MFA”) payload that is generated, during an installation of the software package on the on-premises computing system, at the user device based on an authentication token, a successful MFA authentication, and the first authentication payload, wherein the authentication token is received from one of the cloud service portal and an MFA server associated with the cloud service portal.

18. The apparatus of claim 17, wherein a request is sent, during the installation of the software package, to one of the cloud service portal and the MFA server associated with the cloud service portal, to create an MFA challenge that sends the authentication token to the user device.

19. The apparatus of claim 12, wherein the operations further comprise:
receiving one or more additional authentication payloads from the user device based on a context associated with the user device, wherein the one or more additional authentication payloads are derived at the user device based on one or more additional authentication tokens received from another user device, wherein the another user device is trusted by the on-premises computing system; and
presenting the one or more additional authentication payloads along with the first authentication payload and the second authentication payload to the cloud service portal to access the services via the cloud service portal.

20. A system comprising:
a cloud service portal; and
an on-premises computing system in communication with the cloud service portal, the on-premises computing system comprising a processor and non-transitory computer readable storage media, wherein the on-premises computing system is configured to:
receive, at the on-premises computing system and from the cloud service portal a software package for installation at the on-premises computing system, wherein the software package comprises a first authentication payload,
receive, at the on-premises computing system and from a user device, a second authentication payload,
present, by the on-premises computing system and to the cloud service portal, at least a portion of the first authentication payload and at least a portion of the second authentication payload, and
establish a secured connection between the cloud service portal and the on-premises computing system for accessing services via the cloud service portal in response to a successful validation of the first authentication payload and the second authentication payload.
